(19) United States
(12) Patent Application Publication
(10) Pub. No.: US 2010/0140538 A1
(43) Pub. Date: Jun. 10, 2010

(54) SILICONE ELASTOMER COMPOSITION AND SILICONE ELASTOMER

(76) Inventor: Kazuhiro Sekiba, Chiba (JP)

Correspondence Address: HOWARD & HOWARD ATTORNEYS PLLC, 450 West Fourth Street, Royal Oak, MI, 48067, US

(21) Appl. No.: 12/532,701

(22) PCT Filed: Mar. 14, 2008
(86) PCT No.: PCT/JP2008/055345

§ 371 Date: Feb. 18, 2010

(30) Foreign Application Priority Data
Mar. 26, 2007 (JP) 2007-080292

(51) Int. Cl. C09K 5/00

(52) U.S. Cl. 252/78.3

(57) ABSTRACT

A silicone elastomer composition comprising: (A) an organopolysiloxane having in one molecule on average at least 0.1 silicon-bonded alkenyl groups; (B) an organopolysiloxane having in one molecule on average at least 2 silicon-bonded hydrogen atoms; (C) a platinum group metal catalyst; (D) a thermally conductive filler; (E) an organosiloxane having in one molecule alkenyl groups and silicon-bonded alkoxy groups; and (F) an alkoxysilane compound, suitable for the production of an elastomer characterized by reduced change in hardness even after thermal ageing.

### TECHNICAL FIELD

The present invention relates to a silicone elastomer composition suitable for the production of an elastomer characterized by reduced change in hardness even after thermal ageing.

### BACKGROUND ART

Silicone elastomers are materials that are used for improving electric insulating and thermally conductive properties of electronic devices that contain heat-radiating elements, electronic devices of automobiles that are exposed to high temperatures, etc. For example, thermally conductive silicone elastomer composition for improving thermally conductive properties consists of an organopolysiloxane having in one molecule on average at least 0.1 silicon-bonded alkenyl groups, an organopolysiloxane having in one molecule on average at least 2 silicon-bonded hydrogen atoms, a thermally conductive filler, a platinum group metal catalyst, and a methylpolysiloxane having a hydrolysable group and a vinyl group (see Unexamined Patent Application Publication 2003-213133).

However, in order to improve thermally conductive properties of a silicone elastomer obtained by curing the aforementioned thermally conductive silicone elastomer composition, the latter should be compounded with a large amount of a thermally conductive filler, but when this composition is subjected to thermal ageing, the provision of the aforementioned filler causes significant changes in hardness of the obtained elastomer.

It is an object of the present invention to provide a silicone elastomer composition that produces a silicone elastomer characterized by reduced change in hardness even after thermal ageing.

### DISCLOSURE OF INVENTION

The present invention provides a silicone elastomer composition that comprising:

(A) an organopolysiloxane having in one molecule on average at least 0.1 silicon-bonded alkenyl groups;

(B) an organopolysiloxane having in one molecule on average at least 2 silicon-bonded hydrogen atoms {used in an amount such that the content of silicon-bonded hydrogen atoms contained in the composition ranges from 0.1 to 10 moles per 1 mole of silicon-bonded alkenyl groups contained in component (A)};

(C) a platinum group metal catalyst {used in the amount such that in terms of weight units the content of platinum group metal is in the range of 0.01 to 1,000 ppm per total weight of the components (A) and (B)};

(D) a thermally conductive filler {used in the amount of 25 to 4,500 parts by weight per 100 parts by weight of component (A)};

(E) an organosiloxane represented by the following general formula:

[R¹ₐR²₍₃₋ₐ₎SiO(R²₂SiO)ₘ(R²R⁴SiO)ₙ]_{b}SiR²_{[4-(b+c)]}(OR³)_{c}

{where R¹ represents monovalent hydrocarbon groups having unsaturated aliphatic bonds; R² represents same or different monovalent hydrocarbon groups which are free of unsaturated aliphatic bonds; R³ represents alkyl groups or alkoxyalkyl groups; R⁴ is a group represented by the following general formula:

-A-SiR²_{d}(OR³)_{(3-d)}

(where “A” represents an oxygen atom or a bivalent hydrocarbon group having 2 to 10 carbon atoms; R² and R³ are the same as defined above; and “d” is an integer from 0 to 2); “a” is an integer from 1 to 3; “b” is an integer from 1 to 3; “c” is an integer from 0 to 3; (b+c) is an integer from 1 to 4; “m” is an integer equal to or greater than 0; “n” is an integer equal to or greater than 0, but when “c” is 0, the value of “n” is an integer equal to or greater than 1} {used in the amount of 0.005 to 10 parts by weight per 100 parts by weight of component (D)}; and

(F) a silane compound represented by the following general formula:

R⁵ₑSi(OR⁶)₍₄₋ₑ₎

(where R⁵ represents same or different monovalent hydrocarbon groups, epoxy-containing organic groups, methacrylic-containing organic groups, or acrylic-containing organic groups; R⁶ represents alkyl groups or alkoxyalkyl groups; and “e” is an integer from 1 to 3) (used in the amount of 0.005 to 10 parts by weight per 100 parts by weight of component (D)).

In the silicone elastomer composition of the invention, component (D) may comprise a metal oxide, metal hydroxide, nitride, carbide, graphite, metal, or a mixture thereof.

In the silicone elastomer composition of the invention, component (D) may comprise at least one component selected from aluminium oxide, crystalline silica, zinc oxide, magnesium oxide, titanium oxide, beryllium oxide, aluminium hydroxide, or magnesium hydroxide.

In the silicone elastomer composition of the invention, the surface of component (D) may be surface treated with components (E) and (F) in component (A).

A silicone elastomer of the invention is one obtained by curing the aforementioned silicone elastomer composition.

### EFFECTS OF INVENTION

The effect of the invention consists of reducing changes that may occur in hardness of the silicone elastomer obtained from the silicone elastomer composition of the invention after thermal ageing of the elastomer.

### DETAILED DESCRIPTION OF THE INVENTION

The silicone elastomer composition of the invention will be further described in more detail.

The organopolysiloxane that constitutes component (A) is one of the main components of the composition of the invention. It contains in one molecule on average at least 0.1, preferably at least 0.5, more preferably at least 0.8, and most preferably, at least 2 silicon-bonded alkenyl groups. If one molecule contains alkenyl groups on average in an amount less than the recommended lower limit, the obtained composition will not be completely cured.

The silicon-bonded alkenyl groups of component (A) may be exemplified by vinyl, allyl, butenyl, pentenyl, hexenyl, or hepteny groups, of which preferable are vinyl, allyl, or hexenyl groups. This component may contain organic groups other than alkenyl groups, such as methyl, ethyl, propyl, butyl, octyl, or similar alkyl groups; cyclopentyl, cyclohexyl, or similar cycloalkyl groups; phenyl, tolyl, xylyl, or similar aryl groups; benzyl, phenethyl, or similar aralkyl groups; or 3,3,3-trifluoropropyl, or similar halogenated alkyl groups. Further examples may include small amounts of silanol groups. Preferable are methyl and phenyl groups.

There are no special restrictions with regard to the molecular structure of component (A), and this component may have a linear, branched, partially branched linear, or dendrite molecular structure. Component (A) may comprise a linear-chain polymer, a partially branched single polymer, a copolymer having aforementioned molecular structures, or a mixture of two or more of the aforementioned polymers.

There are no special restrictions with regard to viscosity of component (A) at 25° C., but in order to improve workability of the obtained silicone elastomer composition upon curing and in order to improve the physical properties of the silicone elastomer obtained from the aforementioned composition, the latter should have a viscosity ranging from 50 to 1,000,000 mPa·s, preferably in the range of 200 to 500,000 mPa·s, and most preferably, in the range of 1,000 to 100,000 mPa·s. If viscosity of the composition at 25° C. is below the recommended lower limit, this will impair physical properties of the obtained silicone elastomer. If, on the other hand, viscosity exceeds the recommended upper limit, this will impair handling of the silicone elastomer composition under industrial conditions.

Aforementioned component (A) can be exemplified by the following compounds: a dimethylpolysiloxane capped at both molecular terminals with dimethylvinylsiloxy groups; a dimethylpolysiloxane capped at both molecular terminals with methylphenylvinylsiloxy groups; a copolymer of a methylphenylsiloxane and a dimethylsiloxane capped at both molecular terminals with dimethylvinylsiloxy groups; a copolymer of a methylvinylsiloxane and a dimethylsiloxane capped at both molecular terminals with trimethylsiloxy groups; a copolymer of a methylvinylsiloxane and a dimethylsiloxane capped at both molecular terminals with dimethylvinylsiloxy groups; a methyl (3,3,3-trifluoropropyl) polysiloxane capped at both molecular terminals with dimethylvinylsiloxy groups, a copolymer of a methyl (3,3,3-trifluoropropyl) siloxane and a dimethylsiloxane capped at both molecular terminals with dimethylvinylsiloxy groups, a copolymer of a methylvinylsiloxane and a dimethylsiloxane capped at both molecular terminals with silanol groups; a copolymer of a methylvinylsiloxane, a methylphenylsiloxane, and a dimethylsiloxane capped at both molecular terminals with silanol groups; or an organosiloxane copolymer composed of siloxane units represented by the following formulae: (CH₃)₃SiO_{1/2}, (CH₃)₂(CH₂═CH)SiO_{1/2}, CH₃SiO_{3/2}, and (CH₃)₂SiO_{2/2}.

Component (B) is a cross-linking agent of the composition. This component comprises an organopolysiloxane that has in one molecule on average at least 2 silicon-bonded hydrogen atoms. There are no special restrictions with regard to the positions in which the silicone-bonded hydrogen atoms can be located, so that the hydrogen atoms can be bonded to molecular terminals, side molecular chains, or to both terminals and side molecular chains. Silicon-bonded groups of component (B) other than silicon-bonded hydrogen atoms may be represented by monovalent hydrocarbon groups which do not contain unsaturated aliphatic bonds, such as methyl, ethyl, propyl, butyl, pentyl, hexyl, or similar alkyl groups; cyclopentyl, cyclohexyl, or similar cycloalkyl groups; phenyl, tolyl, xylyl, or similar aryl groups; benzyl, phenethyl, or similar aralkyl groups; or 3,3,3-trifluoropropyl, 3-chloropropyl, or similar halogenated alkyl group. Preferable are alkyl and aryl groups, in particular, methyl and phenyl groups. There are no special restrictions with regard to the molecular structure of component (B), and this component may have a linear, branched, partially branched linear, cyclic, or dendrite molecular structure. Component (B) may comprise a single polymer having these molecular structures, a copolymer having these molecular structures, or mixtures thereof. There are no special restrictions with regard to viscosity of component (B), and the latter may have viscosity ranging at 25° C. from 1 to 100,000 mPa·s, preferably from 1 to 10,000 mPa·s, and most preferably, from 1 to 5,000 mPa·s.

Component (B) of the aforementioned type can be exemplified by the following compounds: a methylhydrogenpolysiloxane capped at both molecular terminals with trimethylsiloxy groups; a copolymer of a methylhydrogensiloxane and a dimethylsiloxane capped at both molecular terminals with trimethylsiloxy groups; a dimethylpolysiloxane capped at both molecular terminals with dimethylhydrogensiloxy groups; a methylhydrogenpolysiloxane capped at both molecular terminals with dimethylhydrogensiloxy groups; a copolymer of a methylhydrogensiloxane and a dimethylsiloxane capped at both molecular terminals with dimethylhydrogensiloxy groups; a cyclic methylhydrogenpolysiloxane; an organosiloxane composed of siloxane units represented by the following formulae: (CH₃)₃SiO_{1/2}, (CH₃)₂HSiO_{1/2}, and SiO_{4/2}; tetra (dimethylhydrogensiloxy) silane, or methyl-tri (dimethylhydrogensiloxy) silane.

In the composition of the invention, component (B) can be used in an amount of 0.1 to 10 moles, preferably 0.1 to 5 moles, and most preferably, 0.1 to 3 moles per 1 mole of silicon-bonded alkenyl groups of component (A). If component (B) is added in an amount less than the recommended lower limit, the silicone elastomer produced from the obtained silicone elastomer composition will be insufficiently cured. If, on the other hand, component (B) is used in the amount exceeding the recommended upper limit, the obtained silicone elastomer will evolve gaseous hydrogen.

The platinum group metal catalyst which constitutes component (C) is a catalyst used to accelerate curing of the composition. Component (C) may be exemplified by platinum group catalysts such as fine platinum powder, platinum black, chloroplatinic acid, platinum tetrachloride, alcohol-modified chloroplatinic acid, platinum complex of olefin, platinum complex of alkenylsiloxane, platinum complex of carbonyl, thermoplastic organic resin powder composed of methylmethacrylate resin, carbonate resin, polystyrene resin, silicone resin, or similar resins and aforementioned platinum group catalysts; rhodium group catalysts expressed by the following formulae: [Rh(O₂CCH₃)₂]₂, Rh(O₂CCH₃)₃, Rh₂(C₈H₁₅O₂)₄, Rh(C₅H₇O₂)₃, Rh(C₅H₇O₂)(CO)₂, Rh(CO)[Ph₃P] (C₅H₇O₂), RhX₃[(R)₂S]₃, (R′₃P)₂Rh(CO)X, (R²₃P)₂Rh(CO)H, Rh₂X₂Y₄, H_{f}Rh_{g}(En)ₕClᵢ, or Rh[O(CO)R]₃₋ⱼ(OH)ⱼ (where X designates a hydrogen atom, chlorine atom, bromine atom, or iodine atom; Y designates a methyl group, ethyl group, or a similar alkyl group, CO, C₈H₁₄, or 0.5 C₈H₁₂; R designates a methyl, ethyl, propyl, or a similar alkyl group; a cycloheptyl, cyclohexyl, or a similar cycloalkyl group; or a phenyl, xylyl or a similar aryl group; R′ designates methyl group, ethyl group, or a similar alkyl group; phenyl, tolyl, xylyl, or a similar aryl group; methoxy, ethoxy, or a similar alkoxy group; “En” designates ethylene, propylene, butene, hexene, or a similar olefin; “f” is 0 or 1; “g” is 1 or 2; “h” is an integer from 1 to 4; “i” is 2, 3, or 4; and “j” is 0 or 1); iridium group catalysts represented by the following formulae: Ir(OOCCH₃)₃, Ir(C₅H₇O₂)₃, [Ir(Z)(En)₂]₂, or [Ir(Z)(Dien)]₂ (where “Z” designates a chlorine atom, bromine atom, iodine atom, of a methoxy group, ethoxy group, or a similar alkoxy group; “En” designates ethylene, propylene, butene, hexene, or a similar olefin; and Dien designates cyclooctadiene).

In the composition of the invention, component (C) is used in an amount such that in terms of weight units the content of platinum group metal is in the range of 0.01 to 1,000 ppm, preferably 0.1 to 500 ppm per the total weight of components (A) and (B). If component (C) is used in the amount less than the recommended lower limit, the obtained silicone elastomer composition will not be sufficiently cured. If, on the other hand, component (C) is added in the amount exceeding the recommended upper limit, this will not significantly accelerate the curing operation.

Component (D) is a thermally conductive filler that imparts to the silicone elastomer obtained by curing the composition of the invention strength and thermally conductive properties. The filler of component (D) may be exemplified by aluminium oxide, crystalline silica, zinc oxide, magnesium oxide, titanium oxide, beryllium oxide, or a similar metal oxide; aluminium hydroxide, magnesium hydroxide, or a similar metal hydroxide; aluminium nitride, silicon nitride, boron nitride, or a similar nitride; boron carbide, titanium carbide, silicon carbide, or a similar carbide; graphite, aluminium, copper, nickel, silver, or a similar metal; as well as mixtures of the above. When it is necessary to impart to the obtained elastomer electrical insulating properties, component (D) may comprise metal oxide, metal hydroxide, nitride, carbide, or a mixture of the above. The use of at least one of the compounds selected from aluminium oxide, crystalline silica, zinc oxide, magnesium oxide, titanium oxide, beryllium oxide, aluminium hydroxide, or magnesium hydroxide is preferable.

There are no special restrictions with regard to the form of component (D), which may have a spherical form, needle-like shape, scale-like shape, or irregular shape. When component (D) is aluminium hydroxide or crystalline silica, it is recommended to have component (D) in the form of spherical or irregular particles. Spherical aluminium oxide comprises mainly α-alumina obtained by a thermospray method or hot-water treatment of aluminium hydroxide. The filler may not be necessarily ideally spherical, and approximately round particles are also acceptable. There are no special restrictions with regard to the average diameter of component (D) particles but in general the particles size should be in the range of 0.01 to 200 μm, preferably in the range of 0.1 to 150 μm, and most preferably, in the range of 0.1 to 100 μm.

There are no special restriction with regard to the amount in which component (D) can be used in the composition of the present invention, but it can be recommended to add component (D) in the amount of 25 to 4,500 parts by weight, preferably 50 to 4,000 parts by weight, and most preferably 100 to 3,000 parts by weight per 100 parts by weight of component (A). If component (D) is added in the amount less than the recommended lower limit, the properties imparted by the filler to the silicone elastomer will be insufficient. If, on the other hand, the amount of added component (D) exceeds the recommended upper limit, this will cause non-uniform distribution of component (D) in the obtained silicone elastomer composition.

The organosiloxane of component (E) is represented by the following general formula:

[R¹ₐR²₍₃₋ₐ₎SiO(R²₂SiO)ₘ(R²R⁴SiO)ₙ]_{b}SiR²_{[4-(b+c)]}(OR³)_{c}

In this formula, R¹ represents a monovalent hydrocarbon group having unsaturated aliphatic bonds. The following are example of such a group: a vinyl, allyl, butenyl, hexenyl, decenyl, undecenyl, dodecenyl, tridecenyl, tetradecenyl, pentadecenyl, hexadcenyl, heptadecenyl, octadecenyl, nonadecenyl, eicosenyl, or a similar linear alkenyl group; an isopropenyl, 2-methyl-2-propenyl, 2-methyl-10-undecenyl, or a similar branched alkenyl group; a vinyl-cyclohexyl, vinyl-cyclododecyl, or a similar cycloalkyl group having unsaturated aliphatic bonds; a vinylphenyl, or a similar aryl group having unsaturated aliphatic bonds; a vinylbenzyl, vinylphenethyl, or a similar aralkyl group having unsaturated aliphatic bonds. Preferable are linear-chain alkenyl groups, in particular, a vinyl, allyl, or a hexenyl group. There are no special restrictions with regard to positions of the unsaturated aliphatic bonds in the group designated by R¹. However, a position remote from the bonded silicon atom is preferable.

In the above formula, R² represents same or different monovalent hydrocarbon groups which are free of unsaturated aliphatic bonds. Examples of such groups are the following: methyl, ethyl, propyl, butyl, hexyl, decyl, or similar linear alkyl groups; isopropyl, tertial-butyl, isobutyl, or similar branched alkyl groups; cyclohexyl, or similar cyclic alkyl groups; phenyl, tolyl, xylyl, or similar aryl groups; benzyl, phenethyl, or similar aralkyl groups. Preferable are alkyl and aryl groups. Most preferable groups are alkyl groups with 1 to 4 carbon atoms, especially methyl and ethyl groups.

In the above formula, R³ represents alkyl groups or alkoxyalkyl groups. Such groups can be exemplified by methyl, ethyl, propyl, butyl, hexyl, decyl, or similar linear alkyl groups; isopropyl, tertial-butyl, isobutyl, or similar branched alkyl groups; cyclohexyl, or similar cyclic alkyl groups; methoxyethyl, ethoxyethyl, methoxypropyl, or similar alkoxyalkyl groups. Preferable are alkyl groups, especially methyl, ethyl, and propyl groups.

In the above formula, R⁴ is a group represented by the following general formula:

-A-SiR²_{d}(OR³)_{(3-d)}

where “A” represents an oxygen atom or a bivalent hydrocarbon group having 2 to 10 carbon atoms. The bivalent hydrocarbon group can be exemplified by the following: ethylene, propylene, butylene, hexenylene, or 2-methylpropylene. Preferable is the ethylene group. In the above formula, R² represents a monovalent hydrocarbon group which is free of unsaturated aliphatic bonds. This group can be exemplified by the same corresponding groups that have been mentioned above. Most preferable are methyl and phenyl groups. Furthermore, in the above formula, R³ represents an alkyl group or an alkoxyalkyl group. These groups are the same as corresponding groups mentioned above, of which preferable are methyl groups. In the above formula, “d” is an integer ranging from 0 to 2, of which 0 is preferable.

In the above formula, “a” is an integer from 1 to 3, preferably 1 or 2, and most preferably 1; “b” is an integer from 1 to 3, preferably 1 or 2, and most preferably 1; “c” is an integer from 0 to 3, preferably 2 or 3, and most preferably 3; (b+c) is an integer from 1 to 4, preferably 3 or 4, and most preferably 4.

In the above formula, “m” is an integer equal to or greater than 0, preferably an integer from 0 to 150, more preferably 0 to 100, and most preferably 0 to 50; “n” is an integer equal to or greater than 0, preferably 0 to 50, but when “c” is 0, the value of “n” is an integer equal to or greater than 1, preferably 1 to 50, more preferably 1 to 10, and most preferably 1 to 5.

The method for the preparation of the organosiloxane of component (E) may consist, e.g., of conducting an alkoxy-exchange reaction between an oligosiloxane which is capped at a molecular terminal with a silanol group and is expressed by the following general formula:

R¹ₐR²₍₃₋ₐ₎SiO(R²₂SiO)ₘH

and an alkoxysilane compound that has in one molecule at least 2 silicon-bonded alkoxy groups, the reaction being carried out in the presence of an acid catalyst such as, e.g., acetic acid.

In the above formula, R¹ represents a monovalent hydrocarbon group having unsaturated aliphatic bonds. Such monovalent hydrocarbon groups can be exemplified by the same groups as mentioned above. Furthermore, in the above formula, R² may designate the same or different monovalent hydrocarbon groups which are free of unsaturated aliphatic bonds, and these hydrocarbon groups can be exemplified by respective groups given above as examples.

In the above formula, “a” is an integer from 1 to 3, preferably 1 or 2, and most preferably 1; “m” is an integer equal to or greater than 0, preferably an integer in the range of 0 to 150, more preferably in the range 0 to 100, and most preferably in the range of 0 to 50.

On the other hand, the alkoxysilane compound that has in one molecule at least 2 silicon-bonded alkoxy groups is represented by the following formula:

R²₍₄₋ₖ₎Si(OR³)ₖ.

This compound can be exemplified by the same appropriate compounds that were mentioned above. In the above formula, R³ is an alkyl group or an alkoxyalkyl group and can be exemplified by the same compounds that were given above for such groups. In the above formula, “k” is an integer from 2 to 4, and preferably 4. The following are examples of the aforementioned alkoxysilane compound: dimethoxydimethylsilane, dimethoxydiethylsilane, diethoxydimethylsilane, diethoxydiethylsilane, or a similar dialkoxydialkylsilane compound; trimethoxymethylsilane, trimethoxyethylsilane, trimethoxypropylsilane, triethoxymethylsilane, triethoxyethylsilane, or a similar trialkoxyalkylsilane compound; tetramethoxysilane, tetraethoxysilane, tetrapropoxysilane, or a similar tetraalkoxysilane compound. Furthermore, the catalyst may comprise acetic acid, propionic acid, or a similar acid.

The organosiloxane of aforementioned component (E) can be exemplified by compounds of the following formulae:

(CH₂═CH)(CH₃)₂SiO[(CH₃)₂SiO]₃Si(OCH₃)₃

(CH₂═CH)(CH₃)₂SiO[(CH₃)₂SiO]₅Si(OCH₃)₃

(CH₂═CHCH₂)(CH₃)₂SiO[(CH₃)₂SiO]₅Si(OCH₃)₃

(CH₂═CHCH₂CH₂CH₂CH₂)(CH₃)₂SiO[(CH₃)₂SiO]₅Si(OCH₃)₃

(CH₂═CH)(CH₃)₂SiO[(CH₃)₂SiO]₇Si(OCH₃)₃

(CH₂═CH)(CH₃)₂SiO[(CH₃)₂SiO]₇Si(OC₂H₅)₃

(CH₂═CHCH₂)(CH₃)₂SiO[(CH₃)₂SiO]₇Si(OCH₃)₃

(CH₂═CHCH₂CH₂CH₂CH₂)(CH₃)₂SiO[(CH₃)₂SiO]₇Si(OCH₃)₃

(CH₂═CH)(CH₃)₂SiO[(CH₃)₂SiO]₇SiCH₃(OCH₃)₂

(CH₂═CH)(CH₃)₂SiO[(CH₃)₂SiO]₂₅Si(OCH₃)₃

(CH₂═CH)(CH₃)₂SiO[(CH₃)₂SiO]₂₇Si(OCH₃)₃

(CH₂═CHCH₂)(CH₃)₂SiO[(CH₃)₂SiO]₂₅Si(OCH₃)₃

(CH₂═CHCH₂CH₂CH₂CH₂)(CH₃)₂SiO[(CH₃)₂SiO]₂₅Si(OCH₃)₃

(CH₂═CH)(CH₃)₂SiO[(CH₃)₂SiO]₂₅Si(OC₂H)₃

(CH₂═CH)(CH₃)₂SiO[(CH₃)₂SiO]₂₇Si(OC₂H₅)₃

(CH₂═CH)(CH₃)₂SiO[(CH₃)₂SiO]₂₅SiCH₃(OCH₃)₂

(CH₂═CH)(CH₃)₂SiO[(CH₃)₂SiO]₅₀Si(OCH₃)₃

(CH₂═CH)(CH₃)₂SiO[(CH₃)₂SiO]₁₀₀Si(OCH₃)₃

(CH₂═CH)(CH₃)₂SiO[(CH₃)₂SiO]₁₅₀Si(OCH₃)₃

(CH₂═CHCH₂)(CH₃)₂SiO[(CH₃)₂SiO]₅₀Si(OCH₃)₃

(CH₂═CHCH₂CH₂CH₂CH₂)(CH₃)₂SiO[(CH₃)₂SiO]₅₀Si(OCH₃)₃

(CH₂═CH₃)₂SiO[(CH₃)₂SiO]₅₀Si(OC₂H₅)₃

(CH₂═CH)(CH₃)₂SiO[(CH₃)₂SiO]₅₀SiCH₃(OCH₃)₂

(CH₂═CH)(CH₃)₂SiO[(CH₃)₂SiO]₅[(CH₃){(CH₃O)₃SiC₂H₄}SiO]₁Si(CH₃)₃

(CH₂═CH)(CH₃)₂SiO[(CH₃)₂SiO]₅[(CH₃){(CH₃O)₃SiO}SiO]₁Si(CH₃)₃

(CH₂═CH)(CH₃)₂SiO[(CH₃)₂SiO]₅[(CH₃){(CH₃O)₃SiC₂H₄}SiO]₁Si(OCH₃)₃

(CH₂═CH)(CH₃)₂SiO[(CH₃)₂SiO]₅[(CH₃){(CH₃O)₃SiO}SiO]₁Si(OCH₃)₃

In the composition of the invention, component (E) should be used in the amount of 0.005 to 10 parts by weight, preferably 0.01 to 8 parts by weight, and most preferably, 0.01 to 5 parts by weight per 100 parts by weight of component (D). If component (E) is used in an amount less than the recommended lower limit, then the increased amount of component (D) will either impair moldability of the composition or will facilitate separation and precipitation of component (D) during storage of the composition. If, on the other hand, the amount of added component (E) is greater that the recommended upper limit, this will impair physical properties in the obtained silicone elastomer.

A silane compound (F) that contains a hydrolysable group is represented by the following general formula:

R⁵ₑSi(OR⁶)₍₄₋ₑ₎

(where R⁵ represents monovalent hydrocarbon groups, epoxy-containing organic groups, methacrylic-containing organic groups, or acrylic-containing organic groups. The aforementioned monovalent hydrocarbon groups designated by R⁵ may comprise substituted or non-substituted monovalent hydrocarbon groups such as methyl, ethyl, propyl, butyl, hexyl, decyl, or similar linear alkyl groups; isopropyl, tertiary-butyl, isobutyl, or similar branched alkyl groups; cyclohexyl, or similar cyclic alkyl groups; vinyl, allyl, butenyl, pentenyl, hexenyl, heptenyl, or similar alkenyl groups; phenyl, tolyl, xylyl, or similar aryl groups; benzyl, phenethyl, or similar aralkyl groups; 3,3,3-trifluoropropyl, 3-chloropropyl, or similar halogenated alkyl groups. The epoxy-containing organic groups designated by R⁵ are exemplified by 3-glycidoxypropyl, or 2-(3,4-epoxycyclohexyl)ethyl groups. The methacrylic-containing organic groups designated by R⁵ may be exemplified by 3-methacryloxypropyl groups. The acrylic-containing organic groups designated by R⁵ may be exemplified by 3-acryloxypropyl groups. In the above formula, R⁶ represents alkyl groups or alkoxyalkyl groups, which are the same as aforementioned groups designated by R³; and “e” is an integer from 1 to 3, preferably 1 or 2, and most preferably 1.

The aforementioned silane compound of component (F) can be exemplified by the following: methyltrimethoxysilane, methyltriethoxysilane, ethyltrimethoxysilane, n-propyltrimethoxysilane, butyltrimethoxysilane, pentyltrimethoxysilane, vinyltrimethoxysilane, vinyltriethoxysilane, methylvinyldimethoxysilane, allyltrimethoxysilane, allylmethyldimethoxysilane, butenyltrimethoxysilane, 3-glycidoxypropyltrimethoxysilane, 3-glycidoxypropylmethyldimethoxysilane, 3-glycidoxypropyltriethoxysilane, 3-methacryloxypropyltrimethoxysilane, 3-methacryloxypropyltriethoxysilane, 3-methacryloxypropylmethyldimethoxysilane, 3-acryloxypropyltrimethoxysilane, or 3-acryloxypropylmethyldimethoxysilane.

In the composition of the invention, component (F) should be used in the amount of 0.005 to 10 pats by weight, preferably 0.01 to 8 parts by weight, and most preferably, 0.01 to 5 parts by weight per 100 parts by weight of component (D). If the content of component (F) is below the recommended lower limit, this will increase the content of component (D), and this will either impair formability of the silicone elastomer composition, or will cause separation and precipitation of component (D) during storage. On the other hand, if the content of component (F) exceeds the recommended upper limit, this will impair physical strength of the obtained silicone elastomer.

The surface of component (D) can be treated with components (E) and (F) by different methods which are the following: first the surface of component (D) is treated with component (E) and then with component (F); first the surface of component (D) is treated with component (F) and then with component (E); the surface of component (D) is treated at the same time with both components (E) and (F); the surface of component (D) is treated with component (E) in component (A) and then with component (F); the surface of component (D) is treated with component (F) in component (A), and then with component (E); the surface of component (D) is treated in component (A) with components (E) and (F) simultaneously; the surface of component (D) treated with component (F) is treated with component (E) in component (A); the surface of component (D) treated with component (E) is treated component (F) in component (A). Thus, components (E) and (F) can be present in the composition of the invention either in the form of coatings on the surface of component (D) or can be added individually.

Within the limits that are not contradictory to the objects of the invention, the composition can be combined with various arbitrary components such as fumed silica, precipitated silica, fumed titanium oxide, or a similar filler; the same filler surface hydrophobically treated with an organic silicon compound; pigment, dye, fluorescence, heat-resistant additive, flame retarder other than a triazole-based compound, plasticizer, or an adhesion-imparting agent.

In order to adjust speed of curing and to improve handling of the composition under industrial conditions, the composition may be further combined with compounds such as 2-methyl-3-butyn-2-ol, 2-phenyl-3-butyn-2-ol, 1-ethynyl-1-cyclohexanol, or a similar acetylene-based compound; 3-methyl-3-penten-1-yne, 3,5-dimethyl-3-hexen-1-yne, or a similar en-yne compound. Other additives may comprise hydrazine-based compounds, phosphines-based compounds, mercaptane-based compounds, or similar curing inhibitors. Although there are special restrictions with regard to the amount in which the curing inhibitor can be used, it is recommended to ad this component in the amount of 0.0001 to 1.0 parts by weight per 100 parts by weight of component (A).

There are no restrictions with regard to the form of the composition, and at room temperature the composition may be in the form of grease, slurry, paste, or a clay-like substance. Also, there are no special restrictions with regard to the method of curing. For example, curing can be carried out by retaining the composition at room temperature after forming, or by subjecting the composition after forming to heat treatment at 50 to 200° C. There are no restrictions also with regard to the form of the silicone elastomer prepared from the composition, and the elastomer may be in the form of gel, soft rubber, or hard rubber. Furthermore, in order to improve handling of the elastomer, it is recommended that the elastomer have type A durometer hardness according to JIS K 6253 equal to or greater than 5.

### EXAMPLES

The silicone elastomer composition and the silicone elastomer will be now described in more detail with reference to practical examples. In these examples, all values of viscosity were measured at 25° C. Hardness, tensile strength, elongation, and tensile adhesive shear strength were evaluated by the methods given below with the results shown in Table 1.

### [Measurement of Hardness]

The silicone elastomer composition was subjected to pressure vulcanization for 15 min. at 150° C., and then was heat treated for 1.5 hours in an oven at 150° C. As a result, a 2 mm-thick silicone elastomer sheets were produced and used for forming a three-sheet laminate which was used for measuring hardness according to JIS K 6253 with the use of a type-A durometer (Asuka Rubber Hardness Tester, spring-type hardness measurement instrument, the product of Kobunshi Keiki Co., Ltd.).

### [Measurement of Tensile Strength and Elongation]

The silicone elastomer composition was subjected to pressure curing for 15 min. at 150° C., and then was heat treated for 1.5 hours in an oven at 150° C. As a result, a 2 mm-thick silicone elastomer sheet was produced. This sheet was used for measuring tensile strength and elongation according to JIS K 6251 with the use of a dumbbell specimen No. 3 on the automatic rubber tensile strength test system AGS-J of Shimazu Corporation.

### [Measurement of Tensile Adhesive Shear Strength]

A 1 mm-thick layer of the silicone elastomer composition was sandwiched between aluminum plates (A1050P) so that a bonding area of (25 mm×10 mm) was formed. The package was heated for 1 hour at 150° C. and cured, whereby a bonding test specimen was formed. The obtained specimen was used for measuring tensile adhesive shear strength according to JIS K6850 on a universal tension tester RTC-1325A of Orientec Co., Ltd.

### [Measurement of Thermal Conductivity]

The silicone elastomer composition was subjected to pressure curing for 15 min. at 150° C., and then was heated for 1 hour in an oven at 150° C. The obtained cured body of the silicone elastomer that had dimensions of 50 mm×100 mm×20 mm was used for measuring thermal conductivity by a hot-wire method with the use of a quick thermal conductivity meter QTM-500 of Kyoto Electronics Manufacturing Co., Ltd.

### [Thermal Ageing Test]

The silicone elastomer sheet was heated for 168 hours in an oven at 150° C., and then hardness was measured by the same method as defined above. Coefficient of hardness change was measured by means of the following formula:

Coefficient of Hardness Change (%)=[(H₁−H₀)×100]/H₀

where H₀ is initial hardness, and H₁ is hardness after thermal ageing.

### Practical Example 1

A silicone base was prepared by mixing the components given below in T.K. HIVIS MIX® of Tokushu Kika Kogyo Co., Ltd. for 15 min. at room temperature and then at a reduced pressure below −0.09 MPa for 1 hour at 150° C.: 18.70 parts by weight of a dimethylpolysiloxane having viscosity of 10,000 mPa·s, capped at both molecular terminals with dimethylvinylsiloxy groups (content of vinyl groups=0.135 wt. %); 80.0 parts by weight of alumina powder having round-shaped particles with an average diameter of 11 μm (AS-40; the product of Showa Denko Co., Ltd.); 0.5 parts by weight of a dimethylpolysiloxane represented by the following formula:

CH₂═CH(CH₃)₂SiO[(CH₃)₂SiO]₂₇Si(OCH₃)₃

and 0.15 parts by weight of methyltrimethoxysilane.

After the obtained base was cooled to room temperature, it was mixed with the following components: 0.55 parts by weight of a copolymer of a methylhydrogensiloxane and a dimethylsiloxane having a viscosity of 5.5 mPa·s, capped at both molecular terminals with trimethylsiloxy groups, and having in one molecule on average 3 silicon-bonded hydrogen atoms (content of silicon-bonded hydrogen atoms=0.33 wt. %; content of silicon-bonded hydrogen atoms of this component is 1.5 moles per 1 mole of vinyl groups contained in the dimethylpolysiloxane of the aforementioned base); and 0.005 part by weight of a curing inhibitor in the form of 2-phenyl-3-butyn-2-ol. The obtained mixture was further combined and uniformly mixed with 0.1 part by weight of a platinum catalyst in the form of a platinum complex solution of 1,3-divinyl-1,1,3,3-tetramethyldisiloxane with a content of metallic platinum equal to 0.5 wt. %. As a result, a silicone elastomer composition was prepared.

### Practical Example 2

A silicone base was prepared by mixing the components given below in the T.K. HIVIS MIX® of Tokushu Kika Kogyo Co., Ltd. for 15 min. at room temperature and then at a reduced pressure below −0.09 MPa for 1 hour at 150° C.: 19.70 parts by weight of a dimethylpolysiloxane having viscosity of 10,000 mPa·s, capped at both molecular terminals with dimethylvinylsiloxy groups (content of vinyl groups=0.135 wt. %); 80.0 parts by weight of alumina powder having round-shaped particles with an average diameter of 11 μm (AS-40; the product of Showa Denko Co., Ltd.); 0.1 part by weight of a dimethylsiloxane represented by the following formula:

CH₂═CH(CH₃)₂SiO[(CH₃)₂SiO]₃Si(OCH₃)₃

and 0.15 part by weight of methyltrimethoxysilane.

After the obtained base was cooled to room temperature, it was mixed with the following components: 0.55 parts by weight of a copolymer of a methylhydrogensiloxane and a dimethylsiloxane having a viscosity of 5.5 mPa·s, capped at both molecular terminals with trimethylsiloxy groups, and having in one molecule on average 3 silicon-bonded hydrogen atoms (content of silicon-bonded hydrogen atoms=0.33 wt. %; content of silicon-bonded hydrogen atoms of this component was 1.5 moles per 1 mole of vinyl groups contained in the dimethylpolysiloxane of the aforementioned base); and 0.005 part by weight of a curing inhibitor in the form of 2-phenyl-3-butyn-2-ol. The obtained mixture was further combined and uniformly mixed with 0.1 part by weight of a platinum catalyst in the form of a platinum complex solution of 1,3-divinyl-1,1,3,3-tetramethyldisiloxane with a content of metallic platinum equal to 0.5 wt. %. As a result, a silicone elastomer composition was prepared.

### Practical Example 3

A silicone base was prepared by mixing the components given below in the T.K. HIVIS MIX® of Tokushu Kika Kogyo Co., Ltd. for 15 min. at room temperature and then at a reduced pressure below −0.09 MPa for 1 hour at 150° C.: 38.30 parts by weight of a dimethylpolysiloxane having viscosity of 10,000 mPa·s, capped at both molecular terminals with dimethylvinylsiloxy groups (content of vinyl groups=0.135 wt. %); 60.0 parts by weight of crystalline-silica powder having irregular-shaped particles with an average size of 15 μm (TMC-1; the product of Tatsumori Co., Ltd.); 0.50 part by weight of a dimethylpolysiloxane represented by the following formula:

CH₂═CH(CH₃)₂SiO[(CH₃)₂₇SiO]₃Si(OCH₃)₃

and 0.10 part by weight of methyltrimethoxysilane.

After the obtained base was cooled to room temperature, it was mixed with the following components: 1.00 part by weight of a copolymer of a methylhydrogensiloxane and a dimethylsiloxane having a viscosity of 5.5 mPa·s, capped at both molecular terminals with trimethylsiloxy groups, and having in one molecule on average 3 silicon-bonded hydrogen atoms (content of silicon-bonded hydrogen atoms=0.33 wt. %; content of silicon-bonded hydrogen atoms of this component was 1.5 moles per 1 mole of vinyl groups contained in the dimethylpolysiloxane of the aforementioned base); and 0.005 part by weight of a curing inhibitor in the form of 2-phenyl-3-butyn-2-ol. The obtained mixture was further combined and uniformly mixed with 0.1 part by weight of a platinum catalyst in the form of a platinum complex solution of 1,3-divinyl-1,1,3,3-tetramethyldisiloxane with a content of metallic platinum equal to 0.5 wt. %. As a result, a silicone elastomer composition was prepared.

### Practical Example 4

A silicone elastomer composition was prepared by the same method as in Practical Example 1, except that instead of preparation of the silicone base by mixing for 15 min. at room temperature with subsequent mixing for 1 hour at 150° C. under reduced pressure below −0.09 MPa, mixing was carried out for 1.5 hours at room temperature and under reduced pressure below −0.09 MPa.

### Comparative Example 1

A silicone base was prepared by mixing the components given below in the T.K. HIVIS MIX® of Tokushu Kika Kogyo Co., Ltd. for 15 min. at room temperature and then at a reduced pressure below −0.09 MPa for 1 hour at 150° C.: 15.87 parts by weight of a dimethylpolysiloxane having viscosity of 10,000 mPa·s, capped at both molecular terminals with dimethylvinylsiloxy groups (content of vinyl groups=0.135 wt. %); 80.0 parts by weight of alumina powder having round-shaped particles with an average size of 11 μm (AS-40; the product of Showa Denko Co., Ltd.); and 3.0 parts by weight of a dimethylpolysiloxane represented by the following formula:

CH₂═CH(CH₃)₂SiO[(CH₃)₂SiO]₂₇Si(OCH₃)₃.

After the obtained base was cooled to room temperature, it was mixed with the following components: 1.03 parts by weight of a copolymer of a methylhydrogensiloxane and a dimethylsiloxane having a viscosity of 5.5 mPa·s, capped at both molecular terminals with trimethylsiloxy groups, and having in one molecule on average 3 silicon-bonded hydrogen atoms (content of silicon-bonded hydrogen atoms=0.33 wt. %; content of silicon-bonded hydrogen atoms of this component was 1.5 moles per 1 mole of vinyl groups contained in the dimethylpolysiloxane of the aforementioned base); and 0.005 part by weight of a curing inhibitor in the form of 2-phenyl-3-butyn-2-ol. The obtained mixture was further combined and uniformly mixed with 0.1 part by weight of a platinum catalyst in the form of a platinum complex solution of 1,3-divinyl-1,1,3,3-tetramethyldisiloxane with a content of metallic platinum equal to 0.5 wt. %. As a result, a silicone elastomer composition was prepared.

### Comparative Example 2

A silicone base was prepared by mixing the components given below in the T.K. HIVIS MIX® of Tokushu Kika Kogyo Co., Ltd. for 15 min. at room temperature and then at a reduced pressure below −0.09 MPa for 1 hour at 150° C.: 18.25 parts by weight of a dimethylpolysiloxane having viscosity of 10,000 mPa·s, capped at both molecular terminals with dimethylvinylsiloxy groups (content of vinyl groups=0.135 wt. %); 80.0 parts by weight of alumina powder having round-shaped particles with an average size of 11 μm (AS-40; the product of Showa Denko Co., Ltd.); and 0.6 part by weight of a dimethylpolysiloxane represented by the following formula:

CH₂═CH(CH₃)₂SiO[(CH₃)₂SiO]₃Si(OCH₃)₃.

After the obtained base was cooled to room temperature, it was mixed with the following components: 1.05 parts by weight of a copolymer of a methylhydrogensiloxane and a dimethylsiloxane having a viscosity of 5.5 mPa·s, capped at both molecular terminals with trimethylsiloxy groups, and having in one molecule on average 3 silicon-bonded hydrogen atoms (content of silicon-bonded hydrogen atoms=0.33 wt. %; content of silicon-bonded hydrogen atoms of this component was 1.5 moles per 1 mole of vinyl groups contained in the dimethylpolysiloxane of the aforementioned base); and 0.005 part by weight of a curing inhibitor in the form of 2-phenyl-3-butyn-2-ol. The obtained mixture was further combined and uniformly mixed with 0.1 part by weight of a platinum catalyst in the form of a platinum complex solution of 1,3-divinyl-1,1,3,3-tetramethyldisiloxane with a content of metallic platinum equal to 0.5 wt. %. As a result, a silicone elastomer composition was prepared.

### Comparative Example 3

A silicone base was prepared by mixing the components given below in the T.K. HIVIS MIX® of Tokushu Kika Kogyo Co., Ltd. for 15 min. at room temperature and then at a reduced pressure below −0.09 MPa for 1 hour at 150° C.: 36.50 parts by weight of a dimethylpolysiloxane having viscosity of 10,000 mPa·s, capped at both molecular terminals with dimethylvinylsiloxy groups (content of vinyl groups=0.135 wt. %); 60.0 parts by weight of crystalline-silica powder having irregular-shaped particles with an average size of 15 μm (TMC-1; the product of Tatsumori Co., Ltd.); and 2.10 parts by weight of dimethylpolysiloxane represented by the following formula:

CH₂═CH(CH₃)₂SiO[(CH₃)₂SiO]₂₇Si(OCH₃)₃.

After the obtained base was cooled to room temperature, it was mixed with the following components: 1.30 parts by weight of a copolymer of a methylhydrogensiloxane and a dimethylsiloxane having a viscosity of 5.5 mPa·s, capped at both molecular terminals with trimethylsiloxy groups, and having in one molecule on average 3 silicon-bonded hydrogen atoms (content of silicon-bonded hydrogen atoms=0.33 wt. %; content of silicon-bonded hydrogen atoms of this component was 1.5 moles per 1 mole of vinyl groups contained in the dimethylpolysiloxane of the aforementioned base); and 0.005 part by weight of a curing inhibitor in the form of 2-phenyl-3-butyn-2-ol. The obtained mixture was further combined and uniformly mixed with 0.1 part by weight of a platinum catalyst in the form of a platinum complex solution of 1,3-divinyl-1,1,3,3-tetramethyldisiloxane with a content of metallic platinum equal to 0.5 wt. %. As a result, a silicone elastomer composition was prepared.

TABLE 1

| | | Examples | | | | | | |
|---|---|---|---|---|---|---|---|---|
| | | Practical Examples | | | | Comparative Examples | | |
| Properties | | 1 | 2 | 3 | 4 | 1 | 2 | 3 |
| Hardness | Initial | 64 | 63 | 46 | 63 | 59 | 63 | 44 |
| | Change after | 0 | 2 | 0 | 3 | 12 | 11 | 5 |
| | thermal ageing | | | | | | | |
| | (%) | | | | | | | |

| | | | | | | | |
|---|---|---|---|---|---|---|---|
| Tensile Strength (MPa) | 3.3 | 2.6 | 2.1 | 3.1 | 3.0 | 3.6 | 2.1 |
| Elongation (%) | 122 | 122 | 151 | 116 | 117 | 122 | 161 |
| Tensile adhesive shear | 199 | 73 | 49 | 187 | 101 | 98 | 116 |
| strength (N/cm²) | | | | | | | |
| Thermal conductivity | 1.8 | 1.8 | 0.5 | 1.8 | 1.8 | 1.8 | 0.5 |
| (W/m · K) | | | | | | | |

### INDUSTRIAL APPLICABILITY

The silicone elastomer composition of the present invention is suitable for the production of silicone elastomers that are characterized by reduced change in hardness after thermal ageing. When such elastomers are used for manufacturing parts of heat-emitting electronic devices or electronic parts of automobiles that operate under conditions of increased temperatures, it becomes possible to improve performance reliability of the respective device.

1. A silicone elastomer composition comprising:
(A) an organopolysiloxane having in one molecule on average at least 0.1 silicon-bonded alkenyl groups;
(B) an organopolysiloxane having in one molecule on average at least 2 silicon-bonded hydrogen atoms used in an amount such that the content of silicon-bonded hydrogen atoms contained in the composition ranges from 0.1 to 10 moles per 1 mole of silicon-bonded alkenyl groups contained in component (A);
(C) a platinum group metal catalyst used in an amount such that in terms of weight units the content of platinum group metal is in the range of 0.01 to 1,000 ppm per total weight of the sum of components (A) and (B);
(D) a thermally conductive filler used in an amount of 25 to 4,500 parts by weight per 100 parts by weight of component (A);
(E) an organosiloxane represented by the following general formula:
[R¹ₐR²₍₃₋ₐ₎SiO(R²₂SiO)ₘ(R²R⁴SiO)ₙ]_{b}SiR²_{[4-(b+c)]}(OR³)_{c}
where R¹ represents monovalent hydrocarbon groups having unsaturated aliphatic bonds; R² represents same or different monovalent hydrocarbon groups which are free of unsaturated aliphatic bonds; R³ represents alkyl groups or alkoxyalkyl groups; R⁴ is a group represented by the following general formula:
-A-SiR²_{d}(OR³)_{(3-d)}
where “A” represents an oxygen atom or a bivalent hydrocarbon group having 2 to 10 carbon atoms; R² and R³ are the same as defined above; and “d” is an integer from 0 to 2; “a” is an integer from 1 to 3; “b” is an integer from 1 to 3; “c” is an integer from 0 to 3; (b+c) is an integer from 1 to 4; “m” is an integer equal to or greater than 0; “n” is an integer equal to or greater than 0, but when “c” is 0, the value of “n” is an integer equal to or greater than 1 wherein component (E) is used in an amount of 0.005 to 10 parts by weight per 100 parts by weight of component (D); and
(F) a silane compound represented by the following general formula:
R⁵ₑSi(OR⁶)₍₄₋ₑ₎
where R⁵ represents same or different univalent hydrocarbon groups, epoxy-containing organic groups, methacrylic-containing organic groups, or acrylic-containing organic groups; R⁶ represents alkyl groups or alkoxyalkyl groups; and “e” is an integer from 1 to 3 wherein component (F) is used in an amount of 0.005 to 10 parts by weight per 100 parts by weight of component (D).

2. The silicone elastomer composition according to claim 1, wherein component (D) is a metal oxide, metal hydroxide, nitride, carbide, graphite, metal, or a mixture thereof.

3. The silicone elastomer composition according to claim 1, wherein component (D) is a component of at least one type selected from aluminium oxide, crystalline silica, zinc oxide, magnesium oxide, titanium oxide, beryllium oxide, aluminium hydroxide, or magnesium hydroxide.

4. The silicone elastomer composition according to claim 1, wherein a surface of component (D) is surface treated with components (E) and (F) in component (A).

5. A silicone elastomer obtained by curing the silicone elastomer composition of claim 1.

6. The silicone elastomer composition according to claim 1, wherein component (A) has in one molecule on average at least 0.8 silicon-bonded alkenyl groups.

7. The silicone elastomer composition according to claim 1, wherein component (A) contains organic groups other than the silicon-bonded alkenyl groups, and wherein the organic groups are selected from alkyl groups, cycloalkyl groups, aryl groups, aralkyl, and halogenated alkyl groups.

8. The silicone elastomer composition according to claim 1, wherein component (B) is used in an amount such that the content of silicon-bonded hydrogen atoms contained in the composition ranges from 0.1 to 5 moles per 1 mole of silicon-bonded alkenyl groups contained in component (A).

9. The silicone elastomer composition according to claim 1, wherein an average diameter of particles of component (D) is in the range of 0.01 to 200 μm.

10. The silicone elastomer composition according to claim 1, wherein component (D) is used in an amount of 100 to 3,000 parts by weight per 100 parts by weight of component (A).

11. The silicone elastomer composition according to claim 1, wherein component (E) is used in an amount of 0.01 to 5 parts by weight per 100 parts by weight of component (D), and wherein component (F) is used in an amount of 0.01 to 5 parts by weight per 100 parts by weight of component (D).
